(19) United States
(12) Patent Application Publication
(10) Pub. No.: US 2009/0189135 A1
(43) Pub. Date: Jul. 30, 2009

(54) VEHICLE SUPPORT STAND

(76) Inventor: Pieter Daniel Van Der Westhuizen, Pretoria (ZA)

Correspondence Address: THE CULBERTSON GROUP, P.C., 1114 LOST CREEK BLVD., SUITE 420, AUSTIN, TX, 78746, US

(21) Appl. No.: 12/279,704

(22) PCT Filed: Feb. 15, 2007
(86) PCT No.: PCT/IB2007/050500

§ 371 Date: Nov. 12, 2008

(30) Foreign Application Priority Data
Feb. 17, 2006 (ZA) 2006-01434
Jul. 6, 2006 (ZA) 2006/05591

(51) Int. Cl. B66F 3/24; F16M 11/24; B66F 3/00

(52) U.S. Cl. 254/93 H; 248/157; 248/121; 254/123

(57) ABSTRACT

A motorcycle support stand includes a base (12), support means (14) and a strut (16). The stand (10) further includes elevating means (18). A motorcycle is mountable on the support means and displaceable by means of the elevating means (18) between a lower position, in which the wheels of the motorcycle are on the ground and an elevated position. The strut is connected at one end to the base or support means and at the other end to the motorcycle and it is adjustable to permit the motorcycle to be pivotally displaced when in its elevated position. The motorcycle support stand will permit work to be done on the motorcycle at a height at which it is comfortable to work and also permit the motorcycle to be orientated to facilitate access to the part of the motorcycle on which work is to be done.

THIS INVENTION relates to a vehicle support stand, in particular to a motorcycle support stand.

When work has to be done on a motorcycle it is often difficult to have it at a convenient height and position.

In the context of this specification the term motorcycle is to be understood to include other two wheeled vehicles such as mopeds, scooters and the like.

According to the invention there is provided a motorcycle support stand which includes

a base;

support means mounted on the base, configured to support a motorcycle at a region between its wheels, at least part of the support means being displaceable relative to the base between a lower position in which a motorcycle is mountable on or dismountable from the support stand and an elevated working position; and

an adjustable strut for supporting the motorcycle at a region remote from the support means.

The support means may be configured to support a motorcycle so that at least when the support means is in its elevated position the motorcycle is pivotably displaceable about a transverse pivot axis. Typically, displacement of the motorcycle is effected by adjusting the strut.

The support means may define an extendable structure which is displaceable relative to the base, the support stand including elevating means configured to displace the extendable structure between the lower position and the elevated working position.

The support means may include at least one bracing member operable to support the motorcycle at the region between the wheels.

In one embodiment of the invention the bracing member may be a support bar which is configured to pass through a mounting passage provided in the region between the motorcycle wheels. More particularly, the bracing member may be configured to extend through a tubular swing-arm mounting bracket of the motorcycle.

In another embodiment of the invention the support means may include a pair of transversely spaced motorcycle engaging members configured releasably to engage the motorcycle at transversely spaced apart positions.

In one embodiment of the invention, the extendable structure may include a pair of transversely spaced triangular frames displaceable relative to the base about a pivot axis between the lower position and the working position by way of the elevating means.

The support means may include a locking arrangement operable to lock the extendable structure releasably in the working position.

The support means may include two locking members. The locking members may be in the form of support posts operable releasably to engage the extendable structure, thereby locking the extendable structure releasably in the working position. The locking members may be displaceable between engaged positions in which they engage the extendable structure and released positions in which they permit displacement of the extendable structure between its lower and elevated positions. The locking members may be biased towards their engaged positions. The locking members may be pivotably connected to the base. The locking members may be connected to each other via a transverse member.

The elevating means may include a link-lever system, the link-lever system including:

a least one lever arm connected at a fulcrum to the extendable structure;

a runner-track, extending from the base; and

a runner connected to the lever arm, the runner being operable to run along the runner-track.

A handle may be connected to the lever arm.

A lever arm may be connected to each elevating apex of the triangular frame, on respective sides of the triangular frame. A lifting member may be connected between the handles, such that the levers may be operated by operating the lifting member.

The runner-track may be inclined such that the runner runs upwardly on the runner-track when the handle is operated so as to elevate the extendable structure. The runner may be a runner-wheel.

It will be appreciated that the elevating means may be actuated hydraulically, pneumatically, or the like. In a preferred embodiment of the invention, the elevating means may be operated by way of a ratchet.

In another embodiment of the invention the extendable structure may include a frame pivotally connected to the base and a pair of transversely spaced apart posts connected to and protruding from the frame.

The elevating means may include at least one extendable member which is connected to the base and extendable structure so that displacement of the extendable structure between its lower position and its elevated position is achieved by changing the effective length of the extendable member.

The extendable member may include at least two parts which are longitudinally displaceable relative to one another.

The at least two parts may be telescopically displaceable relative to one another.

In one embodiment of the invention one part may be in the form of an elongate tubular sleeve, one end of which is pivotally connected to one of the base and extendable structure, the other part being in the form of a gear rack, part of which is slidably received in the sleeve and an end of which is pivotally connected to the other of the base and the extendable structure, the elevating means including a pinion drivingly engaging the rack.

Drive to the pinion can be manual, electrical or in any suitable fashion. In one embodiment the elevating means includes a crank handle drivingly connected to the pinion. The crank handle may be drivingly connected to the pinion through a gear train.

The motorcycle support stand may include locating means configured releasably to lock at least one gear in a desired position. The locating means may include a locking pin which can be inserted through a hole in the rack or one of the gears in the gear train.

In another embodiment of the invention the extendable member may be in the form of a pressurized fluid operated piston and cylinder arrangement, in particular a hydraulic jack.

The posts may be extendible.

A support formation may be provided on each post. Each support formation may include a saddle within which a bracing member or a vehicle engaging member is receivable and a retaining strap which is displaceable between an open position to permit the introduction into or removal of a bracing member or a vehicle engaging member from the support formation and a closed position in which it is releasably lockable such that the bracing member or vehicle engaging member is held captive in the support formation.

The strut may be adjustable in length, e.g. by having a co-operating screw threaded shank and shackle formations, or the like.

Instead, or in addition, the angular position of the strut may be adjustable. The strut may be pivotably connected to one of the base and support means.

The strut may be operable to engage with a mounting member of the vehicle at a position spaced from the engagement of the vehicle support with the vehicle. The strut may be provided with a mounting aperture at an end thereof, operable to receive the mounting member of the vehicle. The mounting member may be fastened to the strut by way of a bolt, or the like.

The strut may include a primary member and a link member which is connected to and adjustable relative to the primary member, the link member being disconnectably connectable to a motorcycle.

Further aspects of the invention will become apparent by way of example with reference to the accompanying diagrammatic drawings.

In the drawings,

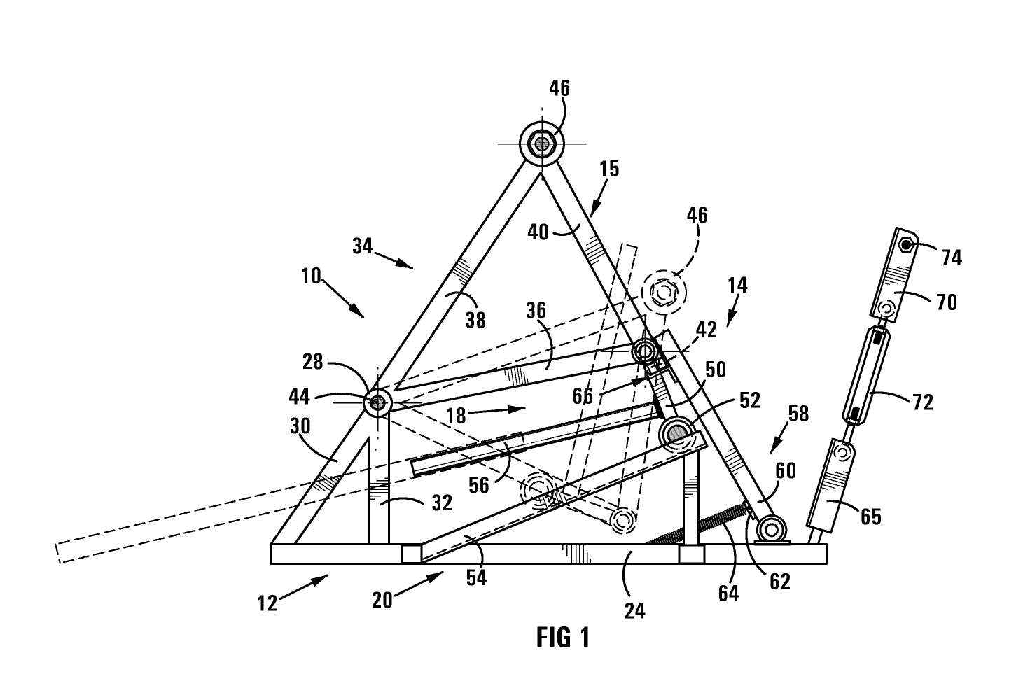

FIG. 1 shows a schematic drawing of an invention, as above described, as applied to a motorcycle stand in a lower position (in dotted lines) and in an elevated working position;

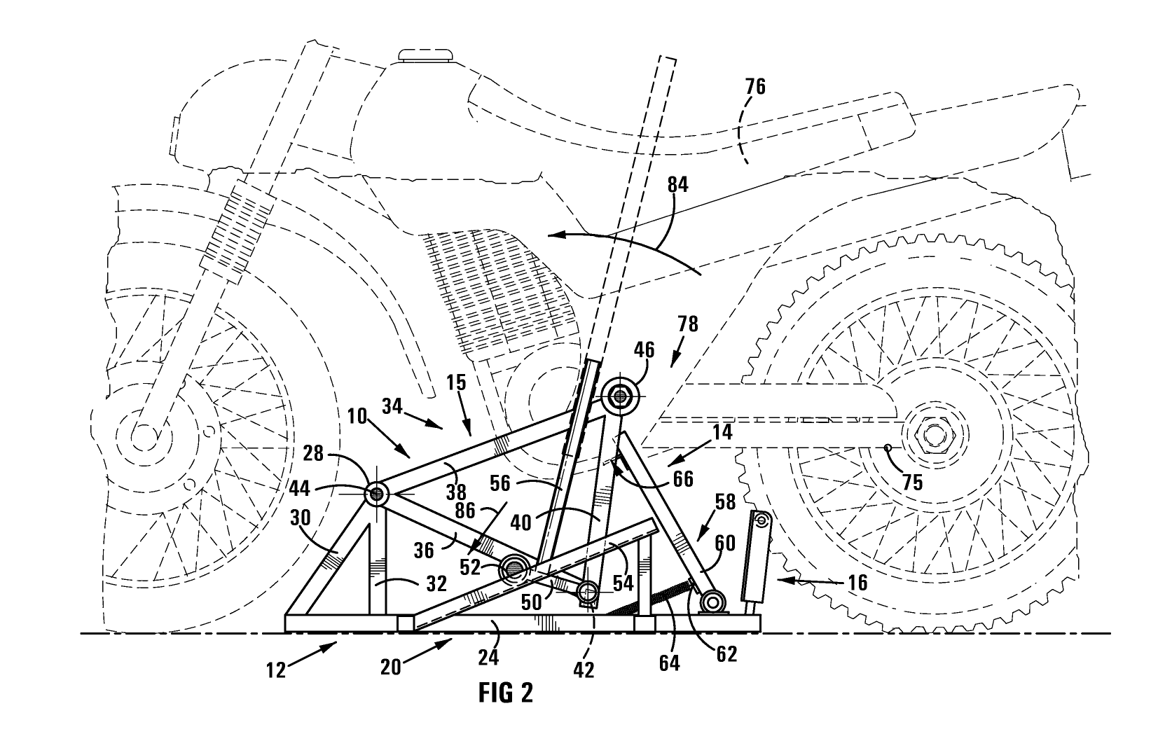

FIG. 2 shows a schematic drawing of the motorcycle stand of FIG. 1 receiving a motorcycle in the lower position;

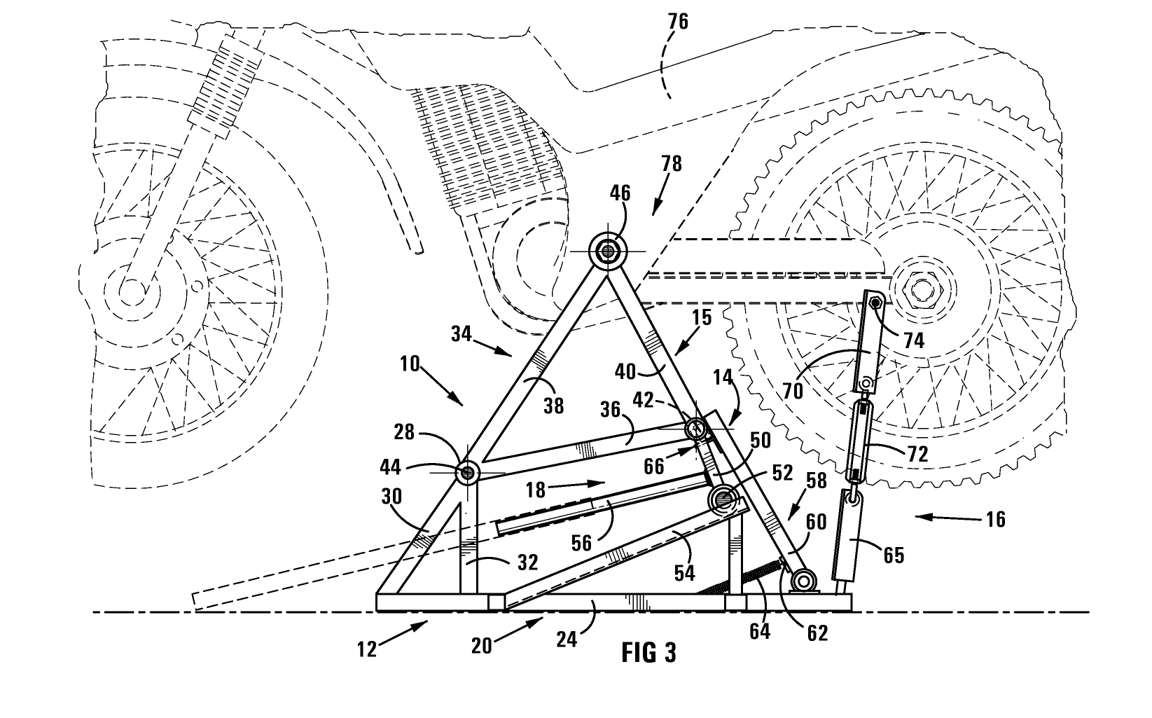

FIG. 3 shows a schematic drawing of the motorcycle stand as above described in an elevated working position;

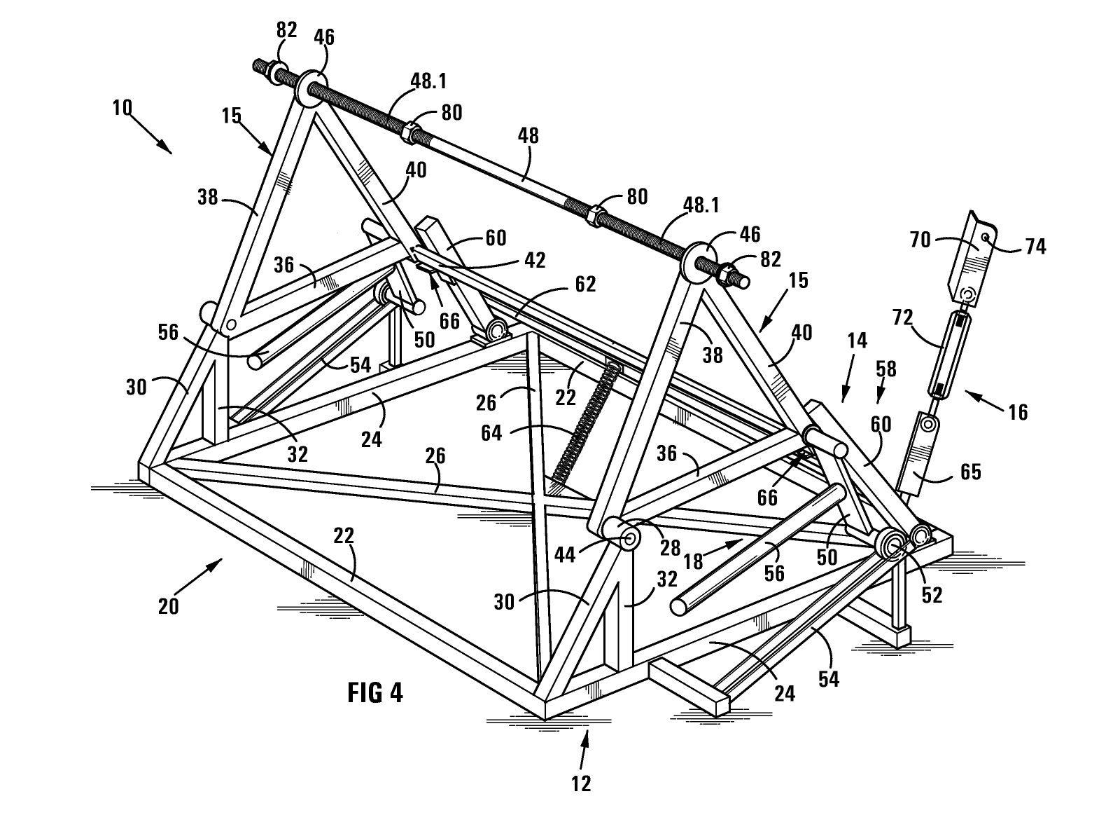

FIG. 4 shows a thee-dimensional schematic drawing of the motorcycle stand, as described above, in the elevated working position;

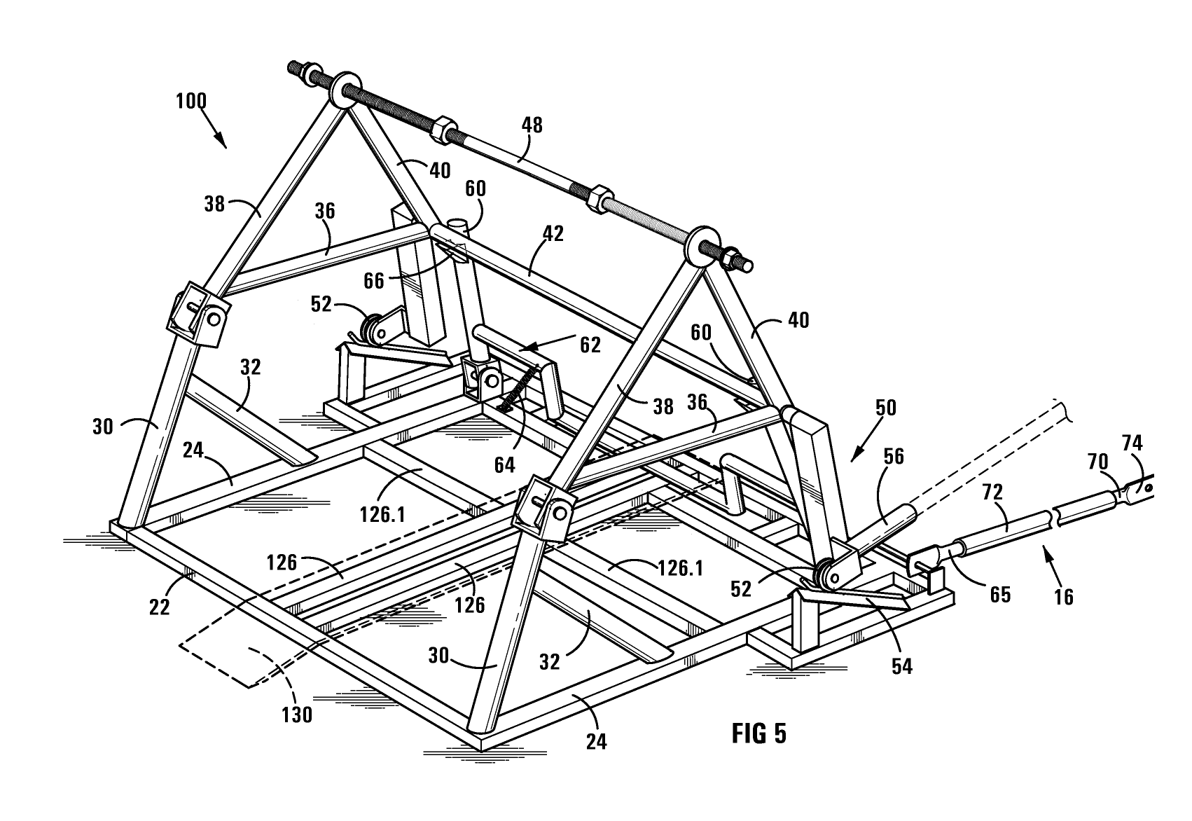

FIG. 5 shows a three-dimensional schematic drawing of another embodiment of the motorcycle stand, as described above, in the elevated working position;

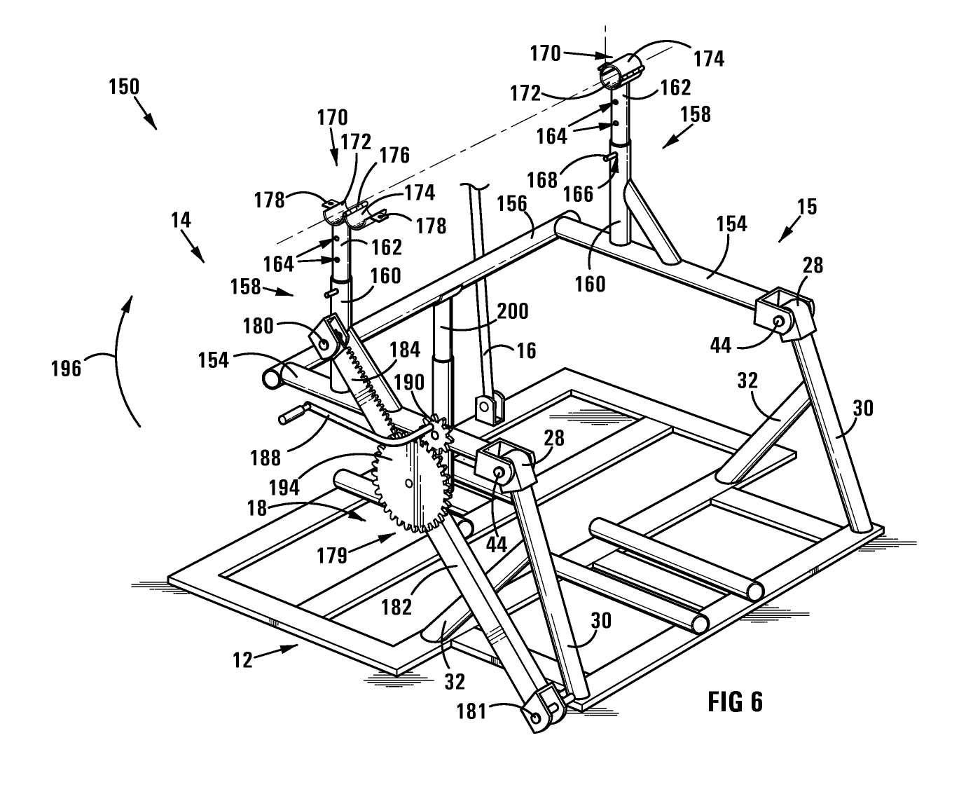

FIG. 6 shows a three-dimensional schematic drawing of another embodiment of the motorcycle stand in accordance with the invention;

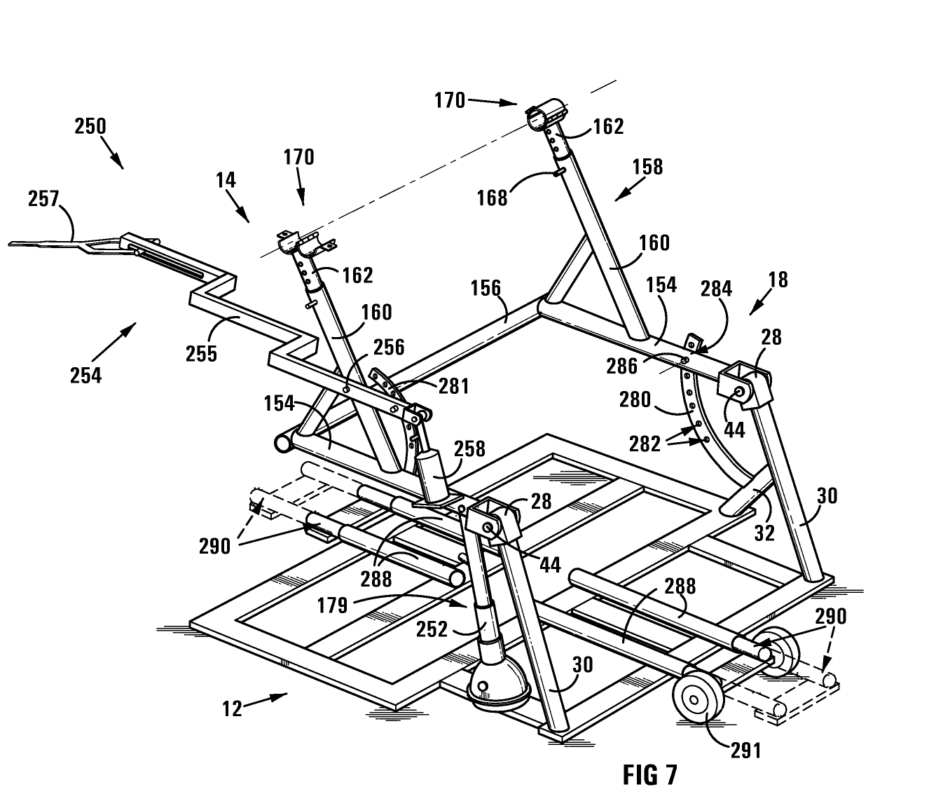

FIG. 7 shows a three-dimensional schematic drawing of yet another embodiment of the motorcycle stand in accordance with the invention;

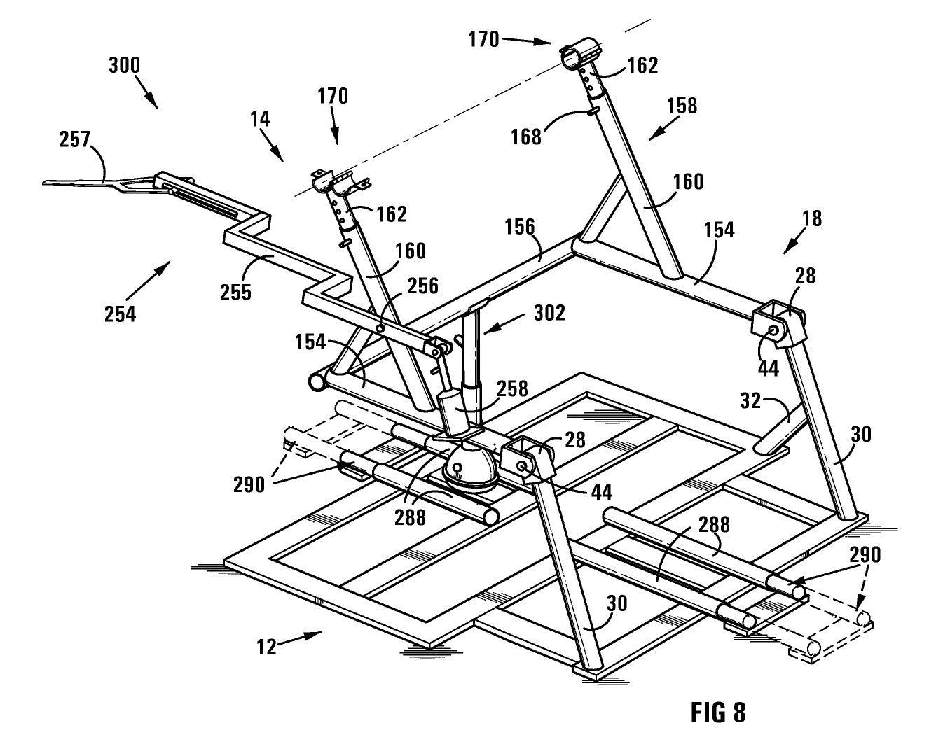

FIG. 8 shows a three-dimensional schematic drawing of still another embodiment of a motorcycle stand in accordance with the invention;

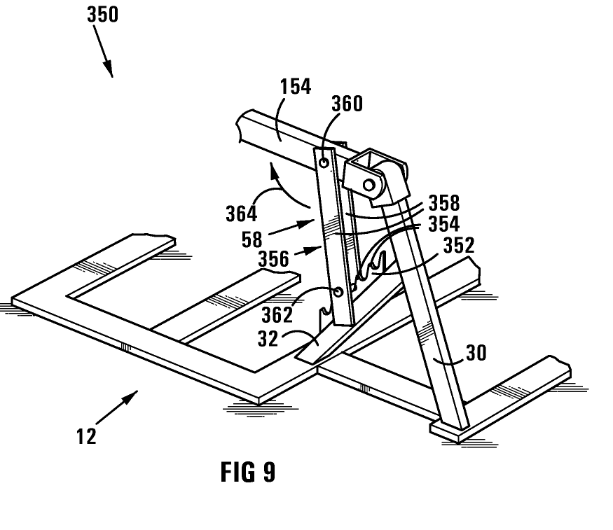

FIG. 9 shows a three-dimensional schematic drawing of part of still another embodiment of a motorcycle stand in accordance with the invention; and

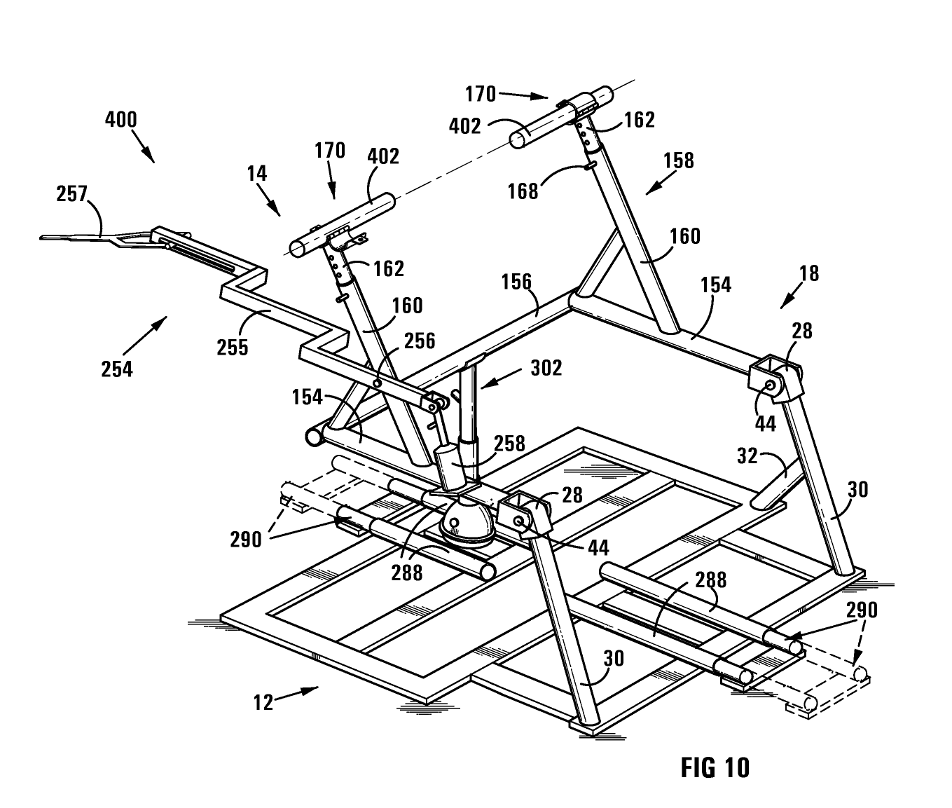

FIG. 10 shows a three-dimensional schematic drawing of yet another embodiment of the motorcycle stand in accordance with the invention.

In FIGS. 1 to 4, reference numeral 10 refers generally to a motorcycle support stand in accordance with the invention. The stand 10 includes a base 12, support means, generally indicated by reference numeral 14 and a strut 16. The stand 10 further includes elevating means, generally indicated by reference numeral 18.

The base 12 includes a rectangular frame 20 comprising parallel side members 22 and parallel end members 24. Diagonal bracing struts 26 extend between and are respectively connected to opposed corners of the frame 20. The base 12 further includes a pair of transversely spaced apart horizontal and axially aligned tubular sleeves 28 each of which is supported by struts 30, 32 connected to and extending upwardly from one of the end members 24.

The support means 14 includes an extendable structure 15 which includes two transversely spaced triangular frames 34 each of which consists of frame members 36, 38, 40 and a transverse bracing element 42 which is connected to and extends between the frames 34. A pivot pin 44 protrudes outwardly from each frame 34 at the intersection of the frame members 36, 38 and is pivotally received in one of the sleeves 28 to permit pivotal displacement of the extendable structure 15 between a lower position (shown in broken lines in FIG. 1 of the drawings) and an elevated working position (shown in solid lines in FIG. 1 of the drawings).

A sleeve 46 is mounted on each frame 34 at the intersection of the frame members 38, 40. A support bar 48 is slidably receivable in the sleeves 46 to support a motorcycle as described in more detail herebelow. End portions 48.1 of the support bar 48 are screw threaded.

To facilitate displacement of the extendable structure 15 between its lower and elevated positions, the elevating means 18 includes a lever arm 50 pivotally connected to each frame 34 at the intersection of the frame members 40, 36. A roller 52 is rotatably mounted on the free end of the lever arm 50. An inclined ramp 54 is connected to the base and provides an inclined surface along which the roller 52 can run. A handle in the form of an elongate bar 56 is connected to the lever arm 50 intermediate its ends and protrudes therefrom.

The vehicle support means 14 includes a locking arrangement, generally indicated by reference numeral 58 to lock the extendable structure releasably in the elevated working position. The locking arrangement 58 includes a pair of posts 60 which are pivotally connected to the base 12 and a transverse member 62 connected to and extending between the posts 60. A coil spring 64 is connected between the transverse member 62 and the diagonal struts 26. Each post 60 is provided with a generally L-shaped engaging formation 66 for engaging releasably with one of the frames 34.

The strut 16 is of composite construction comprising a lower member 65 which is pivotally connected at an operatively lower end thereof to the frame 20, an upper member 70 and an intermediate member 72 connected to and extending between the lower member 65 and upper member 70. The intermediate member 72 is typically in the form of a turn buckle which permits the relative spacing between the lower member 65 and upper member 70 and hence the effective length of the strut to be adjusted. A vehicle engaging member or formation 74 is provided at the free end of the upper member 70, i.e. that end remote from the lower member 65. The engaging members 74 or formations are configured releasably to engage a complementary formation on a motorcycle 76 as described in more detail herebelow.

In use, with the extendable structure 15 in its lower position and the bar 48 removed, a motorcycle 76 is positioned between the frames 34, as shown in FIG. 2 of the drawings. The support bar 48 is inserted through one of the sleeves 46 and then through a tubular passage in a swing arm mounting bracket of the motorcycle 76 and through the other sleeve 46. Nuts 80, screw threadedly mounted on the support bar 48 are then tightened against the ends of the swing arm mounting bracket 78 thereby to lock the support bar 48 against axial movement relative to the motorcycle 76. Similarly, locking nuts 82 mounted on the support bar 48 are screwed against opposed sides of the sleeves 46 to lock the support bar 48 against axial movement relative to the extendable structure.

The extendable structure 15 is then displaced to its elevated working position by displacing the bars 56 in the direction of arrow 84. To this end tubular extension pieces can be mounted on the handles 56 to increase the effective length thereof and thereby reduce the effort required to displace the extendable structure 15 and the motorcycle 76. This in turn causes the lever arms 50 to pivot in the direction of arrow 86 which in turn causes the rollers 52 to roll along the ramp 54. By virtue of the pivoting of the lever arm 50 and the inclination of the ramps 54, the extendable structure 15 is displaced upwardly into its elevated working position which raises the motorcycle 76 into the air.

By virtue of the action of the spring 64 on the transverse member 62, the posts 60 are urged into abutment with the triangular frames 34. When the extendable structure 15 reaches its elevated working position, the formations 66 engage the bracing element 42 to retain the extendable structure releasably in its extended position.

The upper member 70 of the strut 16 is then connected to the swing arm of the motorcycle by means of the engaging member 74 engaging a complementary formation 75 on the swing arm. The length of the strut 16 can then be adjusted in order to pivot the motorcycle 76 about an axis defined by the support bar 48 into a desired orientation.

The desired work can then be performed on the motorcycle at a comfortable height for the person performing the work.

When it is desired to remove the motorcycle from the support stand, the reverse procedure is followed, namely, the strut 16 is disconnected from the motorcycle. The posts and transverse member 60, 62 are displaced outwardly against the bias of the coil spring 64 to disengage the formations 66 from the bracing element 42 permitting the extendable structure 15 to be returned to its lower position by displacing the bar 56 in a direction opposite to the direction of arrow 84.

The support bar 48 can then be removed from the motorcycle permitting it to be wheeled out of the support stand 10.

Instead of making use of the support bar 48, a pair of motorcycle engaging formations may be provided on the triangular frames 34 which formations engage the motorcycle on opposite sides thereof and permit pivotal displacement of the motorcycle 76 by adjusting the strut 16 in the manner described above.

Reference is now made to FIG. 5 of the drawings, in which another embodiment of a motorcycle stand is generally referred to by reference numeral 100. Unless otherwise indicated the same reference numerals, as used above, will be used to refer to similar parts.

The motorcycle stand 100 differs from the motorcycle stand 10 in that a single bar 56 is provided to facilitate displacement of the extendable structure 15 between its lower and elevated positions.

The motorcycle stand 100 includes a strut 16 having an intermediate member 72 which is tubular and which is provided with a female screw thread extending inwardly from each end thereof. End portions of the lower member 65 and upper member 70 are screw-threadedly received in the intermediate member so that the effective length of the strut 16 can be adjusted by rotating the intermediate member 72.

Instead of diagonal struts 26, the motorcycle stand 100 includes spaced apart parallel struts 126 which extend transversely to and between the parallel side members 22. Transverse struts 126.1 extend transversely from parallel end members 24 to the parallel struts 126. A track 130 (shown in broken lines) is provided adjacent, and parallel to the parallel struts 126 so as to allow the motorcycle to be wheeled into the middle of the motorcycle stand 100 more easily. The track may be extendible to form a guide and assist in centering a motorcycle on the stand.

The components 30, 32, 34, 42, 60, and 62 of the motorcycle stand 100 are of tubular construction.

Reference is now made to FIG. 6 of the drawings, in which another embodiment of a motorcycle stand is generally referred to by reference numeral 150. Unless otherwise indicated, the same reference numerals used above are used to designate similar parts. In this embodiment of the invention the extendable structure 15 comprises a generally U-shaped frame having a pair of parallel transversely spaced limbs 154 and a transverse member 156 connected to the one ends of the limbs 154. The frame 152 is pivotally connected to the base 12 by means of pivot pins 44 which are received in the sleeves 28 in the manner described above.

A post 158 is connected to each of the limbs 154 and protrudes therefrom generally perpendicular thereto. Each post 158 includes a tubular lower member 160 which is welded to the limb 154 and protrudes generally perpendicular therefrom and a tubular upper member 162 which is telescopically received in the lower member 160. A plurality of longitudinally spaced apart pairs of diametrically opposed holes 164 is provided in the upper member. A complementary diametrically opposed pair of holes 166 is provided in the lower member. A locking pin 168 is receivable through the holes 166, 164 so as to lock the upper member 162 releasably at a desired position relative to the lower member 160 and thereby permit the effective length of the post 158 to be adjusted.

A support formation 170 is provided at the free end of each post 158. The support formation includes an outwardly open semi-circular base or saddle 172 within which a bracing member or a vehicle engaging member is receivable and a retaining strap 174 which is generally C-shaped and which is hingedly connected at an edge of the saddle 172 by a hinge 176. Complementary locking formations 178 are provided on the saddle 172 and strap 174 to permit the strap 174 to be locked releasably in a closed position in which it functions in a similar manner to the sleeves 46

In this embodiment of the invention the elevating means 18 includes an elongate extendible member 179 which is pivotally connected by means of pivot pins 181, 180 at opposed ends to the base 12 and the lower member 160 of one of the posts 158. The extendible member 176 includes a tubular lower part 182 and an upper part 184 which is in the form of a gear rack part of which is slidably positioned within the lower part 182 such that the extendible member 176 is telescopically extendible. The elevating means further includes a pinion (not shown) which drivingly engages the rack 184. Drive to the pinion is via a crank handle 188 mounted on a gear 190 which is rotatably mounted on a bracket (not shown). The pinion is fixed to a gear 194 which is rotatably mounted on the bracket and with which the gear 190 is drivingly engaged. Hence, the gears 190, 194 together form a gear train providing the desired reduction ratio from the crank handle to the pinion.

In use, with the extendible structure 15 in its lower position and the straps 174 in their open positions, the bar 48 is inserted through the tubular passage in the swing arm mounting bracket of the motorcycle and secured in position. The motorcycle is then wheeled into position and the protruding ends of the support bar 48 are positioned in the saddles 172. The retaining straps 174 are then displaced to their closed positions and locked releasably in position thereby holding the protruding end portions of the support bar captive. The Inventor believes that this arrangement will be easier to use since it is not necessary to align the holes in the sleeves and in the tubular passage in the swing arm.

The crank handle 188 is then rotated so as to rotate the pinion and displace the rack 184 outwardly thereby causing the extendible member 176 to extend. This in turn causes the frame to be displaced in the direction of arrow 196 about a pivot axis defined by the pivot pins 44 thereby raising the motorcycle. When the motorcycle is in the desired position, a locking pin (not shown) is inserted through registering holes in the lower part 182 and the rack 184 thereby to lock the rack in position. Alternatively, a locking element (not shown) can be displaced between the gear teeth of a pair of the gears so as to inhibit relative rotation thereof and lock the extendible structure in its raised position.

It will be appreciated that instead of being manually operable, the pinion may be driven electrically.

If desired, a strut 200 can be positioned between the transverse member 156 and the frame so as to retain the extendible structure 15 in its elevated working position.

The strut 16 is then secured to the motorcycle in the manner described above so as to inhibit displacement of the motorcycle about an axis defined by the support 48.

It will be appreciated that by virtue of the fact that the lengths of the posts 158 are adjustable, the motorcycle stand can be used with a variety of motorcycles.

Reference is now made to FIG. 7 of the drawings, in which reference numeral 250 refers generally to another embodiment of a motorcycle stand in accordance with the invention. Unless otherwise indicated, the same reference numerals used above are used to designate similar parts.

In this embodiment of the invention, the extendible member 179 is in the form of an hydraulically actuated piston and cylinder arrangement, i.e. a bottle jack 252 which is positioned between the base 12 and a limb 154.

A further difference between the stand 250 and the stand 150 is that the stand 250 includes a strut 254. The strut 254 includes an arm or primary member 255 which is pivotally connected by means of a pivot 256 intermediate its ends to a lower member 160 of one of the posts 158 An hydraulically actuated piston and cylinder arrangement, i.e. a bottle jack 258 is mounted between a limb 154 and an end of the arm 255. A motorcycle engaging or link member 257 which is configured to be disconnectably connected to a motorcycle, typically a swing arm thereof, adjacent to a rear wheel is pivotally and/or slidably connected to the other end of the arm 255 so that it can adjust to correspond to the orientation of the swing arm. In particular, a longitudinally extending slot is provided in the arm 255 at that end remote from the jack 258. The motorcycle engaging member 257 has a forked end portion on which is mounted a roller, typically in the form of a roller bearing (not shown) which is held captive in the slotted end portion of the arm 255 and permits limited relative longitudinal displacement between the motorcycle engaging member 257 and the arm 255 and also permits relative pivotal displacement therebetween. If desired in addition to being pivotally mounted on the pivot 256, the arm 255 may be axially displaceable relative to the pivot 256 to permit lateral displacement of the arm to accommodate motorcycles of different widths. The jacks 252, 258 are typically pivotally mounted at both their ends to allow the angle to vary as they are extended and retracted to avoid the build up of stress that would occur if they were rigidly mounted.

In use, the stand 250 is used in substantially the identical fashion to the stand 150. The main differences are that in order to elevate the frame, use is made of the bottle jack 252. At the same time, by making use of the bottle jack 258, the horizontal orientation of a motorcycle supported by the frame can be adjusted. It will be appreciated that instead of the jack other displacement mechanisms could be used. The fact that the motorcycle engaging member 257 is longitudinally and pivotally displaceable relative to the arm 255 permits compensation of the fact that as the motorcycle is pivotally displaced by actuation of the jack 258, the spacing between the point at which the motorcycle engaging member 257 is attached to the motorcycle and the axis about which the motorcycle is pivotally displaced may vary.

In the stand 250 instead of making use of the strut 200 to retain the extendable structure 15 in its elevated working position, use is made of a curved plate 280 which is attached to the strut 32 and centered about the axis defined by the pivot pins 44. A plurality of spaced apart holes 282 is provided in the plate 280. A corresponding hole 284 is provided in one of the limbs 154 and the limb is secured to the plate by a locking pin 286 which is inserted through the holes 284 into one of the holes 282. If desired, a locking arrangement could be provided to lock the arm 255 releasably in a plurality of angularly spaced apart positions. To this end a plate 281 similar to the plate 280 may be connected to one of the limbs 154. The arm 255 is locked in position by a locking pin passing through registering holes in the arm 255 and the plate 281.

As is also clear in FIG. 7 of the drawings, the base 12 includes two pairs of tubular members 288. An extension member 290 is mounted in the tubular members 288 and displaceable between a retracted position (shown in solid lines in FIG. 7 of the drawings) and an extended position (shown in broken lines in FIG. 7 of the drawings) in which they serve to stabilize the stand 250.

The Inventor believes that this arrangement will permit a motorcycle to be supported at an elevated position and its position to be adjusted in a very easy and safe manner.

If desired, a pair of wheels 291 can be mounted at laterally spaced positions on one or both of the extension members 290. When the stand is flat on the ground, as indicated in FIG. 7 of the drawings, the wheels will be clear of the ground. If, however, it is desired to displace the stand 250 from one location to another, it can simply be picked up at one end such that the wheels 291 come into contact with the surface of the ground permitting the stand to be rolled to a desired location.

In addition, if desired, each of the lateral components of the stand 250 may comprise two telescopically interconnected parts permitting the width of the stand to be adjusted to accommodate motorcycles of different sizes.

Reference is now made to FIG. 8 of the drawings, in which reference numeral 300 refers generally to another motorcycle stand in accordance with the invention. Unless otherwise indicated, the same reference numerals used above are used to designate similar parts.

In this embodiment of the invention, the elevating means 18 includes an hydraulically actuated piston and cylinder arrangement, generally indicated by reference numeral 302 which is mounted between the base 12 and the transverse member 156.

Once again, the stand 300 is used in substantially identical fashion to the stand 150.

Reference is now made to FIG. 9 of the drawings, in which reference numeral 350 refers generally to part of another motorcycle stand in accordance with the invention. Unless otherwise indicated, the same reference numerals used above are used to designate similar parts. The main difference between the stand 350 and the stand as described above is in the locking arrangement 58. In the embodiment shown in FIG. 9 of the drawings, the locking arrangement 58 includes a plate 352 attached to the strut 32 and defining a plurality of upwardly directed longitudinally spaced recesses 354. The locking arrangement 58 further includes a stay 356 which comprises a pair of parallel plates 358 which are pivotally connected by means of a pivot pin 360 on opposite sides of one of the limbs 154. A transverse bar 362 extends between the plates 358 at a position adjacent a free end such that the bar 362 is releasably receivable within the slots 354. Accordingly, in use, as the extendible structure is displaced from its lower position towards its elevated position, the bar 362 will automatically engage with the appropriate recess 354 preventing inadvertent displacement of the extendible structure from its elevated to its lower position. When it is desired to displace the extendable structure to its lower position, the stay 356 is displaced in the direction of arrow 364 so that it is no longer in register with the recesses 354 permitting displacement of the extendible structure to its lower position.

Reference is now made to FIG. 10 of the drawings, in which reference numeral 400 refers generally to part of another motorcycle stand in accordance with the invention. Unless otherwise indicated, the same reference numerals used above are used to designate similar parts. The stand 400 is substantially identical to the stand 300 shown in FIG. 8 of the drawings. In this embodiment, use is made of elongate mounting members 402 typically in the form of hollow bar or pipe which are clamped in position in the support formations 170. The mounting members 402 then serve to receive portions of a support bar 48 or of specially made clamps which are mountable on a motorcycle and which facilitate pivoting of the motorcycle relative to the stand.

In addition, the motorcycle stand may be provided with a range of adaptors which can be used to engage the motorcycle instead of the support bar 48.

The invention accordingly extends to a workshop kit which includes a vehicle support stand of the type described above and a plurality of adaptors whereby different motorcycles can be supported on the support stand.

It will be appreciated that operating the motorcycle stand 150, 250, 300, 350, 400 would be similar to operating the motorcycle stand 10, as above described.

The Inventor believes that a vehicle stand in accordance with the invention will provide an efficient and cost effective manner of supporting a motorcycle at an elevation and in an orientation at which it is comfortable to work. More particularly, the Inventor believes that the stand will not only support a motorcycle at an elevated position at which it is comfortable to work but in addition, by virtue of the fact that the motorcycle is pivotally displaceable, typically by 90° or more, access can readily be gained to parts of the motorcycle which otherwise are inaccessible.

In addition, by virtue of its configuration, the Inventor believes that the stand will be capable of supporting a motorcycle at an elevated position in a stable manner without the need for bolting the stand to the ground.

1-33. (canceled)

34. A motorcycle support stand which includes
a base;
support means mounted on the base, configured to support a motorcycle at a region between its wheels, at least part of the support means being displaceable relative to the base between a lower position in which a motorcycle is mountable on or dismountable from the support stand and an elevated working position; and
an adjustable strut for supporting the motorcycle at a region remote from the support means.

35. A motorcycle support stand as claimed in claim 34, in which the support means is configured, when in its elevated working condition, to support a motorcycle so that it is pivotably displaceable about a transverse pivot axis.

36. A motorcycle support stand as claimed in claim 35, in which the support means defines an extendable structure which is displaceable relative to the base, the support stand including elevating means configured to displace the extendable structure between the lower position to the elevated working position.

37. A motorcycle support stand as claimed in claim 36, in which the support means includes at least one bracing member operable to support the motorcycle at the region between the wheels.

38. A motorcycle support stand as claimed in claim 37, in which the bracing member is a support bar which is configured to pass through a mounting passage provided in the region between the motorcycle wheels.

39. A motorcycle support stand as claimed in claim 38, in which the bracing member is configured to extend through a tubular swing-arm mounting bracket of the motorcycle.

40. A motorcycle support stand as claimed in claim 36, in which the support means includes a pair of transversely spaced motorcycle engaging members configured releasably to engage the motorcycle at transversely spaced apart positions.

41. A motorcycle support stand as claimed in any one of claim 36, in which the extendable structure includes a pair of transversely spaced triangular frames displaceable relative to the base about a pivot axis between the lower position and the working position by way of the elevating means.

42. A motorcycle support stand as claimed in claim 41, in which the support means includes a locking arrangement operable to lock the extendable structure releasably in the working position.

43. A motorcycle support stand as claimed in claim 42, in which the support means includes two locking members.

44. A motorcycle support stand as claimed in claim 43, in which the locking members are in the form of support posts operable releasably to engage the extendable structure, thereby locking the extendable structure releasably in the working position.

45. A motorcycle support stand as claimed in claim 44, in which the locking members are displaceable between engaged positions in which they engage the extendable structure and released positions in which they permit displacement of the extendable structure between its lower and elevated positions.

46. A motorcycle support stand as claimed in claim 45, in which the locking members are biased towards their engaged positions.

47. A motorcycle support stand as claimed in claim 46, in which the locking members are pivotably connected to the base.

48. A motorcycle support stand as claimed in any one of claim 45, in which the locking members are connected to each other via a transverse member.

49. A motorcycle support stand as claimed in any one of claim 36, in which the elevating means is a link-lever system, the link-lever system including:
a least one lever arm connected at a fulcrum to the extendable structure;
a runner-track, extending from the base; and
a runner connected to the lever arm, the runner being operable to run along the runner-track.

50. A motorcycle support stand as claimed in claim 49, in which a handle is connected to the lever arm.

51. A motorcycle support stand as claimed in claim 50, in which the runner-track is inclined such that the runner runs upwardly on the runner-track when the handle is operated so as to elevate the extendable structure.

52. A motorcycle support stand as claimed in any one of claim 36, in which the extendable structure includes a frame pivotally connected to the base and a pair of transversely spaced apart posts connected to and protruding from the frame.

53. A motorcycle support stand as claimed in claim 52, in which the elevating means includes at least one extendable member which is connected to the base and extendable structure so that displacement of the extendable structure between its lower position and its elevated position is achieved by changing the effective length of the extendable member.

54. A motorcycle support stand as claimed in claim 53, in which the extendable member includes at least two parts which are longitudinally displaceable relative to one another.

55. A motorcycle support stand as claimed in claim 54, in which the at least two parts are telescopically displaceable relative to one another.

56. A motorcycle stand as claimed in claim 55, in which one part is in the form of an elongate tubular sleeve, one end of which is pivotally connected to one of the base and extendable structure, the other part being in the form of a gear rack, part of which is slidably received in the sleeve and an end of which is pivotally connected to the other of the base and the extendable structure, the elevating means including a pinion drivingly engaging the rack.

57. A motorcycle support stand as claimed in claim 56, in which the elevating means includes a crank handle drivingly connected to the pinion the crank handle being drivingly connected to the pinion through a gear train.

58. A motorcycle support stand as claimed in claim 57, which includes locating means configured releasably to lock at least one gear in a desired position.

59. A motorcycle support stand as claimed in claim 58, in which the locating means includes a locking pin which can be inserted through a hole in the rack or one of the gears in the gear train.

60. A motorcycle support stand as claimed in claim 55, in which the extendable member is in the form of a pressurized fluid operated piston and cylinder arrangement.

61. A motorcycle support stand as claimed in any one of claim 52, inclusive in which a support formation is provided on each post.

62. A motorcycle support stand as claimed in claim 61, in which each support formation includes a saddle within which a bracing member or a vehicle engaging member is receivable and a retaining strap which is displaceable between an open position to permit the introduction into or removal of a bracing member or a vehicle engaging member from the support formation and a closed position in which it is releasably lockable such that the bracing member or vehicle engaging member is held captive in the support formation.

63. A motorcycle support stand as claimed in claim 34, in which the strut is adjustable in length

64. A motorcycle support stand as claimed in claim 34, in which the angular position of the strut is adjustable.

65. A motorcycle support stand as claimed in claim 64, in which the strut is pivotably connected to one of the base and support means.

66. A motorcycle support stand as claimed in claim 65, in which the strut includes a primary member and a link member which is connected to and adjustable relative to the primary member, the link member being disconnectably connectable to a motorcycle.
